(19) United States
(12) Patent Application Publication
(10) Pub. No.: US 2009/0063337 A1
(43) Pub. Date: Mar. 5, 2009

(54) PAYMENT TERMINAL, PAYMENT SYSTEM AND COMPUTER-READABLE MEDIUM

(75) Inventor: Toru IKEDA, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Casio Computer Co., Ltd., Tokyo (JP)

(21) Appl. No.: 12/195,572

(22) Filed: Aug. 21, 2008

(30) Foreign Application Priority Data
Aug. 29, 2007 (JP) 2007-222629

(51) Int. Cl. G06Q 20/00

(52) U.S. Cl. 705/39

(57) ABSTRACT

Disclosed is a payment terminal including: a connection section to connect to a data processing apparatus including an output section to output data; a payment control section to send a first instruction to the data processing apparatus through the connection section to allow the output section to output payment data to be used in payment processing when a payment instruction is received from the data processing apparatus through the connection section, and to perform payment processing; and an output control section to send a second instruction to the data processing apparatus through the connection section to allow the output section to output a result of the payment processing by the payment control section.

### BACKGROUND OF THE INVENTION

1. Field of the Invention

The present invention relates to a payment terminal, payment system and computer-readable medium.

2. Description of the Related Art

A payment system where electronic payment is performed using payment terminals and sales data processing apparatuses such as an Electronic Cash Register (ECR), Point of Sales (POS), etc., provided in stores has been known.

For example, a payment system with a structure where the payment terminal and the sales data processing apparatus are separate is known. With this structure, it is necessary for a clerk to manually input sales data (for example, payment amount) processed by the sales data processing apparatus into the payment terminal. Thus, the clerk needed to perform the task of inputting sales data and also needed to be careful of input error.

Also, a payment system where the payment terminal and the sales data processing apparatus are connected for communication by a cable and the like is also known. With this structure, the sales data is sent to the payment terminal through the cable, etc. Thus, the clerk does not need to manually input the sales data into the payment terminal and there is no possibility of input error.

Further, a payment system using a POS processing terminal (sales data processing apparatus) including a payment processing function is also known (for example, Japanese Patent Application Laid-Open Publication No. 2004-118257, hereinafter referred to as patent document 1).

However, with the above-described technique of patent document 1, the sales data processing apparatus includes the payment processing function. Thus, more time for development (for example, time for software development, etc.) is necessary than sales data processing apparatuses without the payment processing function. When there is a limit in the processing capabilities of the sales data processing apparatus, it is difficult to realize a sales data processing apparatus including a payment function.

In order to solve the problem of the above-described technique of patent document 1, a structure of a payment system where the payment terminal and the sales data processing apparatus are separate and the payment terminal and the sales data processing apparatus are connected for communication by a cable and the like is possible. However, with this structure, when there is a change in a specification of either the payment terminal or the sales data processing apparatus, there is a necessity to adapt to the change in the specification. As an example, a payment terminal including a function compatible with a magnetic card is to change its specification, and a function to be compatible with an Integrated Circuit (IC) card is to be added. In this case, if a function to be compatible with the IC card is not included in the sales data processing apparatus also, payment processing compatible to an IC card cannot be performed. Similarly, when there is a change in a specification of the sales data processing apparatus, the specification of the payment terminal also needs to be changed. Thus, a system which realizes payment processing without necessity of adapting to the change in the specification has been desired.

An object of the present invention is to realize payment processing without necessity of adapting to change in specification.

### SUMMARY OF THE INVENTION

The present invention has been made in consideration of the above situation, and has an advantage of realizing a payment processing without necessity of adapting to change in specification.

In order to achieve any one of the above advantages, according to a first aspect of the present invention, there is provided a payment terminal comprising:

a connection section to connect to a data processing apparatus including an output section to output data;

a payment control section to send a first instruction to the data processing apparatus through the connection section to allow the output section to output payment data to be used in payment processing when a payment instruction is received from the data processing apparatus through the connection section, and to perform payment processing; and

an output control section to send a second instruction to the data processing apparatus through the connection section to allow the output section to output a result of the payment processing by the payment control section.

According to a second aspect of the present invention, there is provided a payment system comprising:

the payment terminal according to claim 1; and

the data processing apparatus according to claim 1, wherein the data processing apparatus comprises:

a connection section of the data processing apparatus to connect to the payment terminal;

an output section to output data; and

a control section to allow the output section to output the payment data or the result of payment processing according to an output form of the output section when the first instruction to output the payment data used in the payment processing or the second instruction to output the result of the payment processing is received from the payment terminal through the connection section of the data processing apparatus.

According to a third aspect of the present invention, there is provided a computer-readable medium embodying a program to allow a computer to function as:

a connection section to connect to a data processing apparatus including an output section to output data;

a payment control section to send a first instruction to the data processing apparatus through the connection section to allow the output section to output payment data to be used in payment processing when a payment instruction is received from the data processing apparatus through the connection section, and to perform payment processing; and

an output control section to send a second instruction to the data processing apparatus through the connection section to allow the output section to output a result of the payment processing by the payment control section.

### BRIEF DESCRIPTION OF THE DRAWINGS

The present invention and the above-described objects, features and advantages thereof will become more fully understood from the following detailed description with the accompanying drawings and wherein;

FIG. 1 is a schematic view showing a payment system of the embodiment;

FIG. 2 is a block diagram showing an inner structure of a payment terminal;

FIG. 3 is a block diagram showing an inner structure of a sales data processing apparatus;

FIG. 4 is a flow chart showing a flow of a first sales data processing performed by the sales data processing apparatus and a flow chart showing a flow of a first payment processing performed by the payment terminal;

FIG. 5 is a flow chart showing a continuation of the flow of the first sales data processing performed by the sales data processing apparatus and a flow chart showing a continuation of the flow of the first payment processing performed by the payment terminal;

FIG. 6A is a diagram showing an example of a display of a guidance message (1);

FIG. 6B is a diagram showing an example of a display of a guidance message (2);

FIG. 6C is a diagram showing an example of a display of a guidance message (3);

FIG. 6D is a diagram showing an example of a display of a guidance message (4);

FIG. 6E is a diagram showing an example of a display of a guidance message (5);

FIG. 7 is a flow chart showing a flow of a second sales data processing performed by the sales data processing apparatus and a flow chart showing a flow of a second payment processing performed by the payment terminal;

FIG. 8 is a flow chart showing a flow of a guidance message display processing; and

FIG. 9 is a flow chart showing a continuation of the flow of the second sales data processing performed by the sales data processing apparatus and a flow chart showing a continuation of the flow of the second payment processing performed by the payment terminal.

### DETAILED DESCRIPTION OF THE PREFERRED EMBODIMENTS

Preferred first and second embodiments of the present invention will be described in detail with reference to the attached drawings. However, the scope of the invention is not limited to the illustrated examples.

### First Embodiment

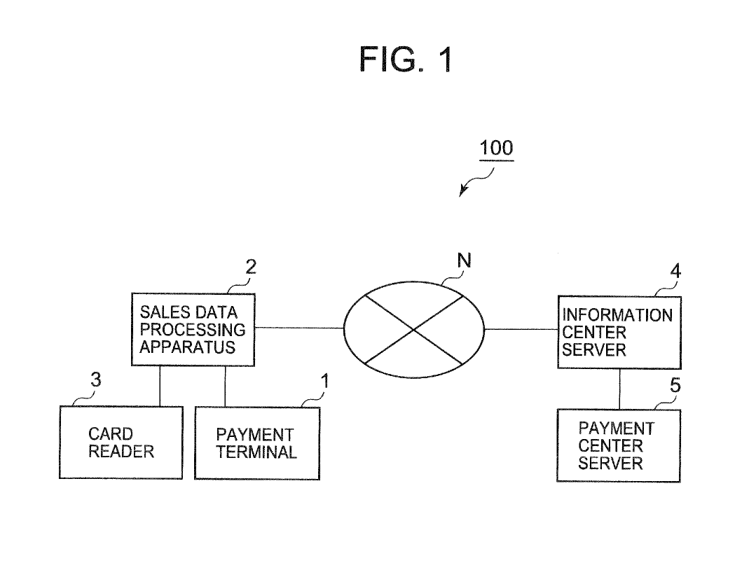

The first embodiment of the present invention will be described with reference to FIG. 1 to FIG. 6. First, a structure of the apparatus of the present embodiment will be described with reference to FIG. 1 to FIG. 3.

FIG. 1 is a diagram showing a structure of the payment system 100 of the present embodiment.

As shown in FIG. 1, the payment system 100 comprises a payment terminal 1, a sales data processing apparatus 2, a card reader 3 connected to the sales data processing apparatus 2, an information center server 4 and a payment center server 5 connected to the information center server 4.

The sales data processing apparatus 2 and the information center server 4 are connected through a communication network N such as the Internet and the like. A Virtual Private Network (VPN) is constructed in the communication network N.

One or a plurality of the sales data processing apparatus 2 may be provided in stores. The information center server 4 is connected to a plurality of sales data processing apparatuses 2 through the communication network N. In the present embodiment, the number of sales data processing apparatuses 2 connected to the information center server 4 is not limited, and may be a scale of several hundred apparatuses or several tens of thousand apparatuses.

In FIG. 1, an example of the card reader 3 connected to the sales data processing apparatus 2 is shown, however, the card reader 3 may be connected to the payment terminal 1.

The information center server 4 includes a store support function for collecting sales data (name of merchandise items, sale proceeds, etc.) sent from the sales data processing apparatus 2 through the communication network N and compiling the collected sales data to provide information (for example, a sales summary report and the like) to support operation of the stores, and a payment function for processing data (for example, card number, expiration date, payment amount, etc.) sent from the payment terminal 1 through the sales data processing apparatus 2 in the payment center server 5.

The payment center server 5 is connected to a server of a credit card company, Credit and Finance Information System (CAFIS; registered trademark) and the like, and is a server for providing online credit information service. In the present embodiment, an online credit information service assumes various services such as checking credit line, validity of a card and the like concerning credit card payment by connecting a credit card company and member store with a communication line.

Next, an inner structure of the payment terminal 1 will be described.

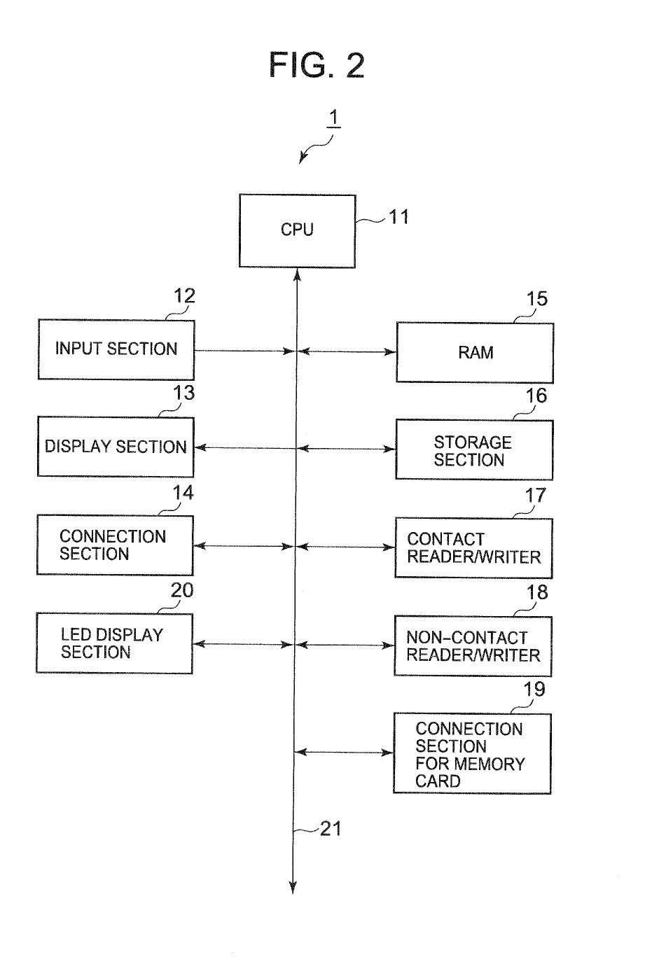

FIG. 2 is a diagram showing the inner structure of the payment terminal 1. As shown in FIG. 2, the payment terminal 1 comprises, a payment control section, a Central Processing Unit (CPU) 11 as an output control section, an input section 12, a display section 13, a connection section 14 as a connection member for connecting to the sales data processing apparatus 2, a Random Access Memory (RAM) 15, a storage section 16, a contact reader/writer 17, a non-contact reader/writer 18, a connection section 19 for connecting a memory card and a Light Emitting Diode (LED) display section 20 as an indicator, and the sections are connected to each other by a bus 21.

The CPU 11 centrally controls the sections of the payment terminal 1. The CPU 11 develops to the RAM 15 a designated program from a system program and various application programs stored in the storage section 16, and performs various processing in coordination with the program developed to the RAM 15.

When the CPU 11 receives a payment command from the sales data processing apparatus 2 through the connection section 14, in coordination with a first payment processing program, the CPU 11 sends a command to the sales data processing apparatus 2 through the connection section 14 to display payment data on a display section 33 of the sales data processing apparatus 2 and performs payment processing. The CPU 11 sends a command to the sales data processing apparatus 2 through the connection section 14 to output a payment result on the display section 33 or to a print section 37 of the sales data processing apparatus 2. The payment data corresponds to a later-described guidance message. The guidance message is data used in the payment processing. Specifically, the guidance message is data including operation information, payment amount, etc. The payment result corresponds to a later-described sales slip print data. The sales slip print data is data printed on a sales slip. Specifically, the sales slip print data includes a name of traded merchandise item, amount of money, etc.

The input section 12 includes function keys such as numeric input keys and the like, and outputs an operation signal of the key operation to the CPU 11.

The display section 13 includes a display such as a Liquid Crystal Display (LCD), and performs a required display processing according to a display control signal input from the CPU 11.

The connection section 14 includes a connection terminal for serial connection between the payment terminal 1 and the sales data processing apparatus 2, and sends and receives data between the payment terminal 1 and the sales data processing apparatus 2.

The RAM 15 develops a control program performed by the CPU 11 to the program storage area. The RAM 15 temporarily stores in a work area input data and data of a processing result of performing the control program. The RAM 15 also stores transaction data (payment data, etc.) of each transaction by electronic payment.

The storage section 16 includes a Hard Disc Drive (HDD), a nonvolatile semiconductor memory (flash ROM), etc., and stores a control program performed by the CPU 11, data necessary when the control program is performed, and the like.

The contact reader/writer 17 includes a contact terminal for contact with a card such as an IC card provided with a contact electrode on a card surface, and when the card is in contact with the contact terminal, reads and writes data stored in the card (card number, expiration date, etc.).

The non-contact reader/writer 18 reads and writes by wireless communication data recorded on a recording medium such as an electronic payment card or IC card embedded with a non-contact IC chip when the recording medium is within a readable/writable range. For example, the recording medium includes a card such as an electronic payment card or IC card embedded with a non-contact IC chip, or a portable terminal including a credit function. Here, a portable terminal means a portable terminal apparatus such as a cellular phone, Personal Digital Assistant (PDA), portable laptop computer, etc.

In the present embodiment, the electronic payment card is a credit card for micropayment. As a form of electronic payment card, the present embodiment assumes a normal card shape form or an electronic payment card function incorporated in a cellular phone.

The connection section 19 includes a connector, a socket and the like, and a memory card is connected.

The LED display section 20 includes a plurality of LEDs (for example, LEDs such as green, white, red, blue, etc.). On and off of the LEDs can be controlled by a driving signal from the CPU 11. The LED display section 20 notifies a customer of a status of the payment processing. For example, when in a status of standing by for the electronic payment card to be held to the terminal, the green LED is turned on. When in a status where the payment processing is finished, the white LED is turned on. When in an error status, the red LED is turned on. When in processing, the blue LED is turned on.

Next, an inner structure of the sales data processing apparatus 2 will be described.

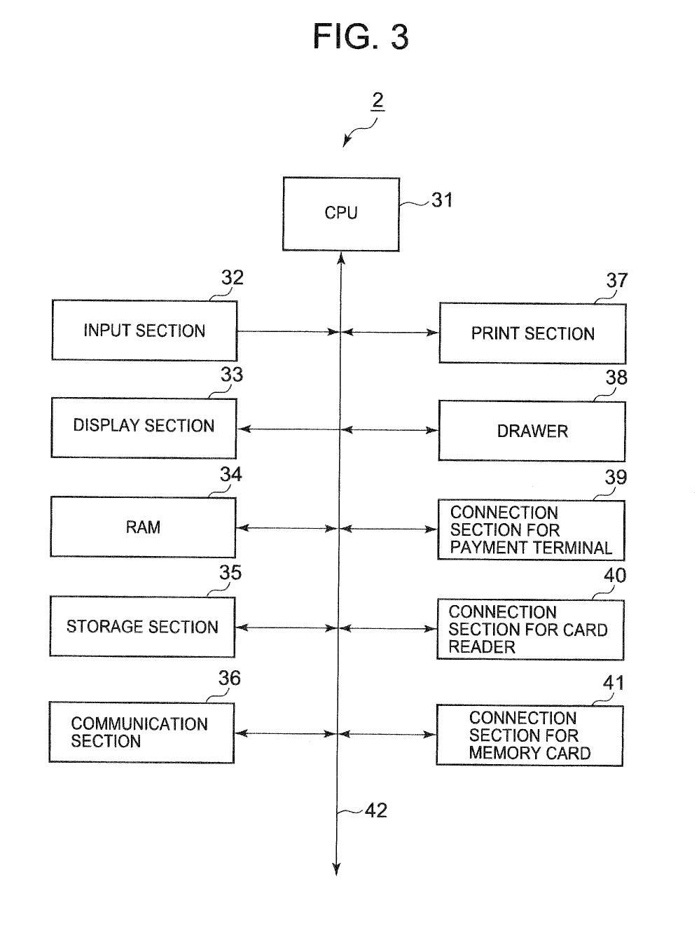

FIG. 3 is a diagram showing the inner structure of the sales data processing apparatus 2. As shown in FIG. 3, the sales data processing apparatus 2 includes a CPU 31 as a control section, an input section 32 as an input section, the display section 33 as an input section and an output section, a REM 34, a storage section 35, a communication section 36, the print section 37 as an output section, a drawer 38, a connection section 39 as a communication section of the sales data processing apparatus 2 for connecting to the payment terminal 1, a connection section 40 for connecting the card reader 3 and a connection section 41 for connecting the memory card, and the sections are connected to each other through a bus 42.

The CPU 31 reads out a control program stored in the storage section 35 to develop to the RAM 34, and performs various processing In coordination with a first sales data processing program, the CPU 31 allows the display section 33 to display a guidance message on the display section 33. The CPU 31 allows the print section 37 to print sales slip print data.

The input section 32 includes a keyboard for a register comprising a cursor key, character and numeric input keys, and various function keys, and an operation signal of the key pressed down by the operator is output to the CPU 31. The input section 32 may be a touch panel integrated to the display section 33. The input section 32 may include a barcode reader or barcode scanner for reading a barcode provided on a merchandise item.

The display section 33 includes a display such as an LCD, etc., and performs a required display processing according to a display control signal input from the CPU 31 The RAM 34 develops the control program performed by the CPU 31 to the program storage area. The RAM 34 temporarily stores in a work area input data and data of a processing result of performing the control program. The RAM 34 includes a sum memory and the like for adding the sales data of each transaction to be stored.

The storage section 35 includes an HDD, a nonvolatile semiconductor memory, etch, and stores a control program performed by the CPU 31, data necessary when the control program is performed, and the like.

The communication section 36 controls connection and communication with the information center server 4 through the communication network N.

The print section 37 is, for example, a thermal printer including rolls of paper for a receipt to be given to the customer and for a journal to be kept by the store (for recording the content of the transaction of the merchandise items), and according to the print control signal (print command) input from the CPU 31, prints on the rolls name of the traded merchandise item, amount of money, etc., in a form of a sales slip.

The drawer 38 is a drawer for sorting and storing cash in a plurality of types of coins and notes, and the drawer opens by a signal from the CPU 31 according to operation of the input section 32 (pressing down the cash/deposit key).

The connection section 39 includes a connection terminal for serial connection between the payment terminal 1 and the sales data processing apparatus 2, and sends and receives data between the payment terminal 1 and the sales data processing apparatus 2.

The connection section 40 includes a connection terminal for connecting a card reader 3 which reads a magnetic card including a magnetic stripe with a magnetic reading apparatus, and receives read data input from the card reader 3 The connection section 41 includes a connector, a socket, and the like, and a memory card is connected. The memory card stores an electronic register code as identification information of the sales data processing apparatus 2 and connection information of the information center server 4 (IP address of the information center server 4, port number of the various services provided by the information center server 4, etc.). The CPU 31 reads out the connection information stored in the memory card and accesses to the information center server 4.

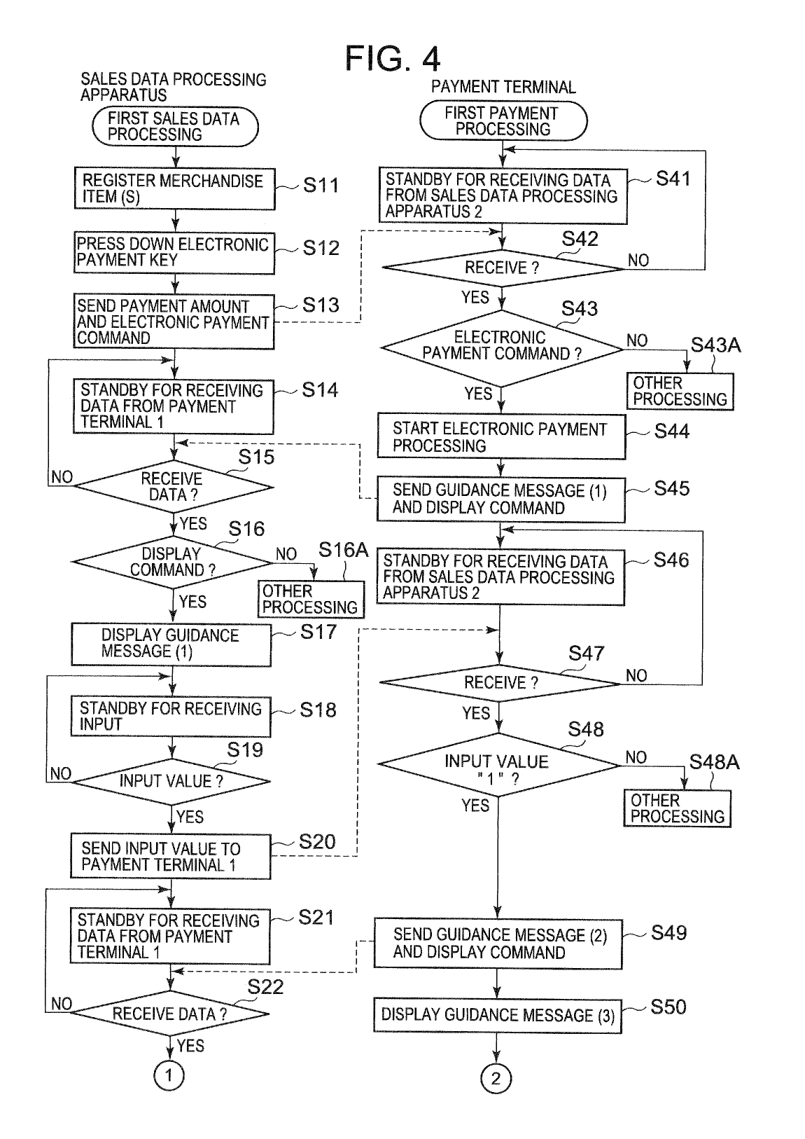

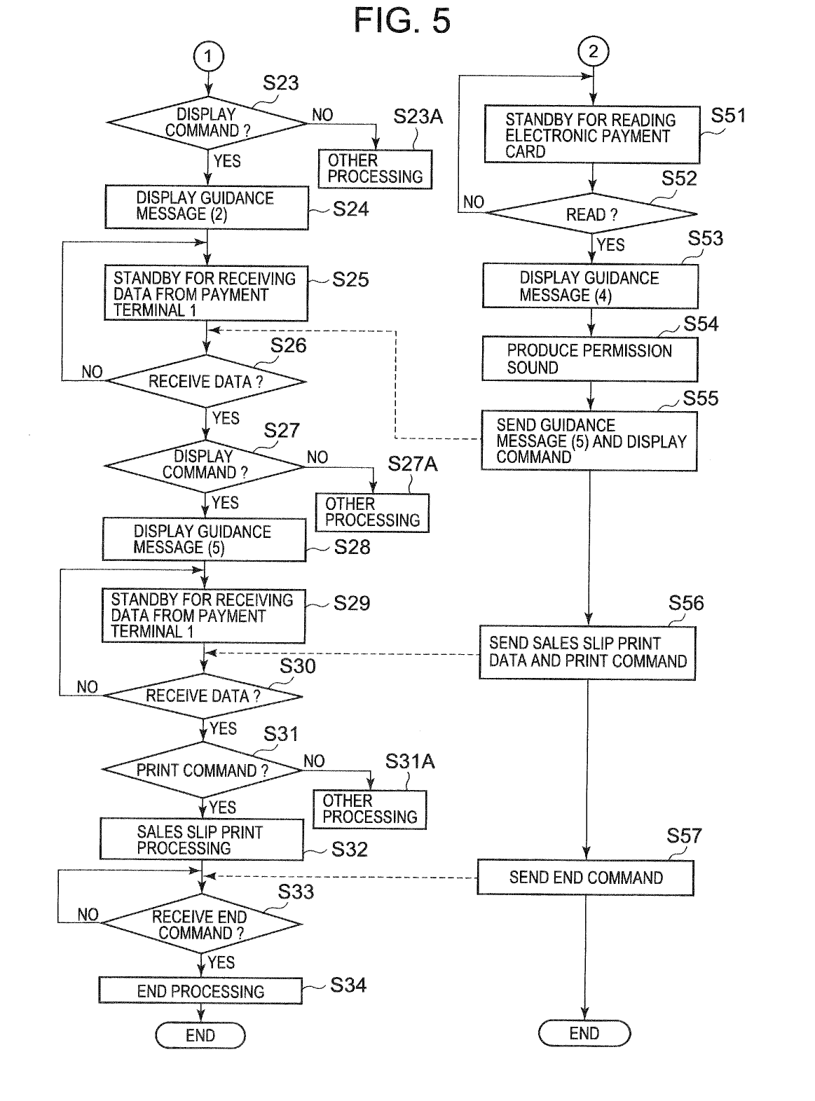

Next, an operation of the payment system 100 will be described with reference to FIG. 4 and FIG. 5.

FIG. 4 is a flow chart showing a flow of the first sales data processing performed by the sales data processing apparatus 2 and a flow chart showing a flow of the first payment processing performed by the payment terminal 1.

FIG. 5 is a flow chart showing a continuation of the flow of the first sales data processing performed by the sales data processing apparatus 2 and a flow chart showing a continuation of the flow of the first payment processing performed by the payment terminal 1.

The following description assumes payment processing by a customer using an electronic payment card.

The first sales data processing performed by the sales data processing apparatus 2 will be described. For example, when there is an instruction to perform the first sales data processing through the input section 32, in coordination with the CPU 31 and the first sales data processing program read out from the storage section 35 and developed to the RAM 34, the sales data processing apparatus 2 performs the first sales data processing.

First, an input of merchandise item registration is received (step S11). The merchandise item registration is, for example, inputting through the input section 32 (barcode reader) information of the merchandise item purchased by the customer (for example, name of merchandise items and sale proceeds) to register information of the merchandise item in the memory. Then, pressing of an electronic payment key is accepted (step S12). The electronic payment key is an input key for instructing that a micropayment using an electronic payment card will be performed by the customer. In other words, to press the electronic payment key means the sales data will not be paid in cash but micropayment using an electronic payment card by reading the electronic payment card with the payment terminal 1 will be performed. In the present embodiment, to perform micropayment using an electronic payment card is called “electronic payment”.

After step S12, a payment amount and an electronic payment command is sent to the payment terminal 1 through the connection section 39 (step S13). Then, the apparatus stands by for receiving data from the payment terminal 1 through the connection section 39 (step S14).

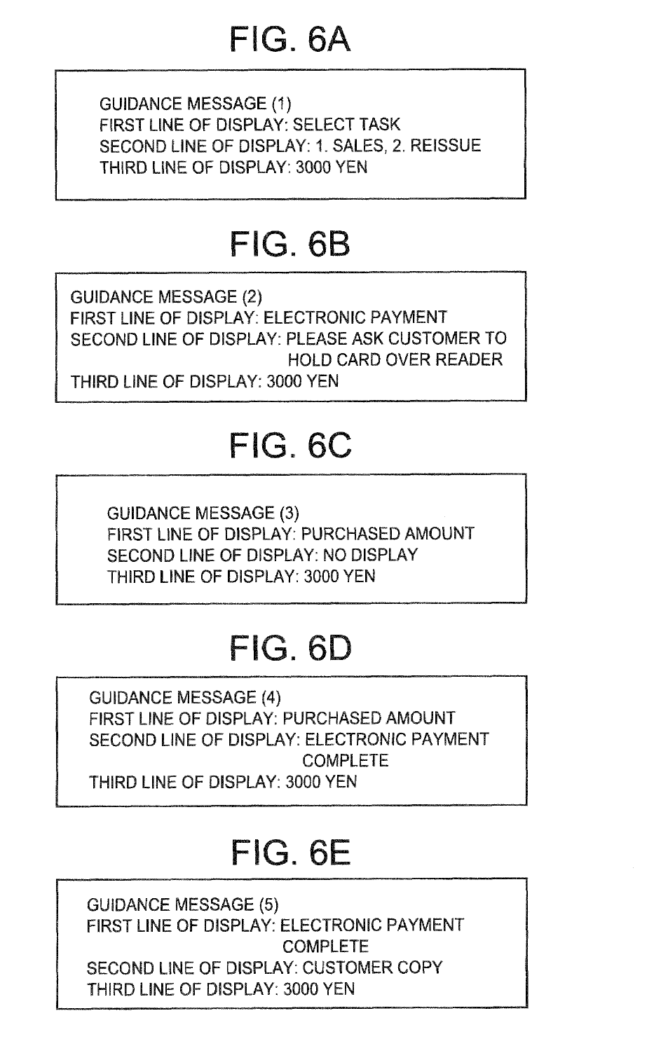

After step S14, corresponding to step S45, it is determined whether or not data is received from the payment terminal 1 through the connection section 39 (step S15). In other words, it is determined whether or not a guidance message (1) and a display command of the guidance message (1) are received. The guidance message (1) is the message shown in FIG. 6A. Specifically, the message is displayed with “select task” in the first line, “1. sales, 2. reissue” in the second line, and “3000 yen” in the third line. When it is determined the data is not received from the payment terminal 1 (step S15; NO), the processing returns to step S14.

In step S14, when it is determined that the data is received from the payment terminal 1 (step S15; YES), it is determined whether or not the received data includes the display command of the guidance message (1) (step S16). When it is determined the display command of the guidance message (1) is not included (step S16; NO), the processing advances to a different processing (step S16A). Other processing is, for example, error processing to allow the display section 33 to display an error message, print processing (when an instruction to perform print processing is received from the payment terminal 1), etc.

In step S16, when it is determined the display command of the guidance message (1) is included (step S16; YES), the guidance message (1) is displayed on the display section 33 (step S17). Then, the apparatus is on standby for receiving input (step S18). To be on standby for receiving input is to be on standby for input of selection by the user of “sales” or “reissue” of the guidance message (1) through the input section 32.

After step S18, it is determined whether or not an input value is received (step S19). The input value is the number “1” or “2” of the “1. sales” or “2. reissue” of the guidance message (1). In other words, in this step, it is determined whether or not the input of selection by the user of “1” or “2” is received through the input section 32. Here, when the input section 32 and the display section 33 are configured as a touch panel, the input of the input value may be performed by pressing displayed areas of “1. sales” or “2. reissue” displayed on the touch panel. When it is determined the input value is not received (step S19; NO), the processing returns to step S18. When it is determined that the input value is received (step S19; YES), the input value is sent to the payment terminal 1 through the connection section 39 (step S20).

Then, the apparatus is on standby for receiving data from the payment terminal 1 (step S21). After step S21, corresponding to step S49, it is determined whether or not the data is received from the payment terminal 1 through the connection section 39 (step S22). In other words, it is determined whether or not a guidance message (2) and a display command of the guidance message (2) are received. The guidance message (2) is the message shown in FIG. 6B. Specifically, the message is displayed with “electronic payment” in the first line, “Please ask customer to hold the card over reader” in the second line, and “3000 yen” in the third line. When it is determined the data is not received from the payment terminal 1 (step S22; NO), the processing returns to step S21.

Here, “to hold the card over reader” is to hold the electronic payment card near the non-contact reader/writer 18 of the payment terminal 1 to perform reading and writing of the data stored in the non-contact IC chip embedded in the electronic payment card.

In step S22, when it is determined the data is received from the payment terminal 1 (step S22; YES), it is determined whether or not the received data includes the display command of the guidance message (2) (step S23). When it is determined the display command of the guidance message (2) is not included (step S23; NO), the processing advances to a different processing (step S23A).

In step S23, when it is determined the display command of the guidance message (2) is included (step S23; YES), the guidance message (2) is displayed on the display section 33 (step S24).

Then, the apparatus is on standby for receiving data from the payment terminal 1 (step S25). After step S25, corresponding to step S55, it is determined whether or not the data is received from the payment terminal 1 through the connection section 39 (step S26). In other words, the apparatus is on standby for receiving a guidance message (5) and a display command of the guidance message (5) The guidance message (5) is the message shown in FIG. 6E. Specifically, the message is displayed with “electronic payment complete” in the first line, “customer copy” in the second line, and “3000 yen” in the third line. When it is determined the data is not received from the payment terminal 1 (step S26; NO), the processing returns to step S25.

In step S26, when it is determined the data is received from the payment terminal 1 (step S26; YES), it is determined whether or not the received data includes the display command of the guidance message (5) (step S27). When it is determined the display command of the guidance message (5) is not included (step S27; NO), the processing advances to a different processing (step S27A).

In step S27, when it is determined the display command of the guidance message (5) is included (step S27; YES), the guidance message (5) is displayed on the display section 33 (step S28).

Then, the apparatus is on standby for receiving data from the payment terminal 1 (step S29) After step S29, corresponding to step S56, it is determined whether or not the data is received from the payment terminal 1 through the connection section 39 (step S30). In other words, it is determined whether or not sales slip print data and a print command of the sales slip print data are received. Here, the print command of the sales slip print data may be a display command of the sales slip print data. When it is determined the data is not received (step S30; NO), the processing returns to step S29.

In step S30, when it is determined the data is received (step S30; YES), it is determined whether or not the received data includes the sales slip print command (step S31). When it is determined the received data does not include the sales slip print command (step S31; NO), the processing advances to a different processing (step S31A).

In step S31, when it is determined the received data includes the sales slip print command (step S31; YES), the sales slip print instruction processing is performed (step S32). Specifically, the processing to print the result of the payment on a sales slip is performed through the print section 37. When the display command of the sales slip print data is received in step S30, the sales slip print data may be displayed on the display section 33 in this step.

Then, it is determined whether or not an end command is received from the payment terminal 1 through the connection section 39 (step S33). When it is determined the end command is not received (step S33; NO), the processing returns to step S33. When it is determined the end command is received (step S33; YES), the end processing is performed (step S34) and the first sales data processing ends.

Next, the first payment processing performed by the payment terminal 1 will be described. For example, when there is an instruction to perform the first payment processing through the input section 12, in coordination with the CPU 11 and the first payment processing program read out from the storage section 16 and developed to the RAM 15, the payment terminal 1 performs the first payment processing.

First, the terminal is on standby for receiving data from the sales data processing apparatus 2 through the connection section 14 (step S41). Then, corresponding to step S13, it is determined whether or not the data is received from the sales data processing apparatus 2 through the connection section 14 (step S42). In other words, it is determined whether or not a payment amount and an electronic payment command are received from the sales data processing apparatus 2 through the connection section 14. When it is determined the data is not received (step S42; NO), the processing returns to step S41.

When it is determined the data is received (step S41; YES), it is determined whether or not the received data includes the electronic payment command (step S43). When it is determined the received data does not include the electronic payment command (step S43; NO), the processing advances to a different processing (step S43A) When it is determined the received data includes the electronic payment command (step S43; YES), the electronic payment processing starts (step S44).

After step S44, the guidance message (1) and the display command of the guidance message (1) is sent to the sales data processing apparatus 2 through the connection section 14 (step S45). Then, the terminal is on standby for receiving data from the sales data processing apparatus 2 (step S46). Then, corresponding to step S20, it is determined whether or not the data is received from the sales data processing apparatus 2 through the connection section 14 (step S47). In other words, it is determined whether or not the input value is received from the sales data processing apparatus 2.

When it is determined the data is not received (step S47; NO), the processing returns to step S46. When it is determined the data is received (step S47; YES), it is determined whether or not the input value of the received data is “1” (step S48). When it is determined the input value of the received data is not “1” (step S48; NO), other processing is performed (step S48A). For example, when the input value is “2: reissue”, a reissuing processing is performed.

In step S48, when it is determined the input value of the received data is “1” (step S48; YES), the guidance message (2) and the display command of the guidance message (2) are sent to the sales data processing apparatus 2 through the connection section 14 (step S49).

After step S49, a guidance message (3) is displayed on the display section 13 (step S50) The guidance message (3) is the message shown in FIG. 6C. Specifically, the message is displayed with “purchased amount” in the first line, “no display” in the second line, and “3000 yen” in the third line. Here, the green LED (standby for the card to be held to the terminal) of the LED display section 20 is turned on.

After step S50, the terminal is on standby for reading the electronic payment card (step S51). Then, it is determined whether or not the reading of the electronic payment card is performed (step S52). In other words, it is determined whether or not the reading of the electronic payment card is performed by the non-contact reader/writer 18.

In step S52, when it is determined the reading of the electronic payment card is not performed (step S52; NO), the processing returns to step S51. In step S52, when it is determined the reading of the electronic payment card is performed (step S52; YES), a guidance message (4) is displayed on the display section 13 (step S53). The guidance message (4) is the message shown in FIG. 6D. Specifically, the message is displayed with “purchased amount” in the first line, “electronic payment complete” in the second line and “3000 yen” in the third line. Here, the green LED of the LED display section 20 is turned off and the white LED is turned on.

After step S53, a permission sound is produced from the sound producing section which is not shown (step S54). By producing the permission sound, the customer can know the payment is complete. Then, the guidance message (5) and the display command of the guidance message (5) is sent to the sales data processing apparatus 2 through the connection section 14 (step S55).

After step S55, the sales slip print data and the sales slip print instruction is sent through the connection section 14 (step S56). Then, an end command is sent to the sales data processing apparatus 2 through the connection section 14 and the first payment processing ends.

As described above, according to the present embodiment, the payment terminal 1 allows the sales data processing apparatus 2 to output the guidance messages (guidance message (1), guidance message (2) and guidance message (5)) and the sales slip print data, and thus the sales data processing apparatus 2 only needs to display the guidance message or print the sales slip print data according to the instruction from the payment terminal 1. Consequently, for example, when there is a change in the specification of the payment terminal 1, the sales data processing apparatus 2 may perform the payment processing without a need to respond to the change in the specification.

Also, for example, when there are two types of the sales data processing apparatus 2 where a device specification of the input section 32 (for example, specification of the input button) are different, but a device specification of the display section 33 (for example, specification of a number of lines of data displayed) or a device specification of the print section 37 (for example, specification of size of width of sheet to be printed) of the sales data processing apparatus 2 are the same in the two apparatuses, the two types of apparatuses can be used with the same payment terminal 1. In other words, as long as the specification of the display device or the print device of the sales data processing apparatuses 2 are the same, even if there are a plurality of sales data processing apparatuses 2 with different device specifications in devices other than the display section 33 or the print section 37 (for example, input section 32), the payment terminal 1 may perform the payment processing regardless of the sales data processing apparatuses 2.

The sales data processing apparatus 2 only needs to display or print according to the instruction by the payment terminal 1, thus, even if the processing capabilities are low, the display processing or the print processing is possible. The processing capabilities of the sales data processing apparatus 2 may be low, thus the cost of the sales data processing apparatus 2 may be reduced.

The payment terminal 1 can deal with partial payment (a case that payment is done individually). As an example, it is assumed at payment for a meal at a restaurant, a plurality of customers (a plurality of customers having a meal together) pay with different methods of payment (one pays with cash, another pays with an electronic payment card, etc.). In this case, the payment terminal 1 receives an instruction of payment in cash from the sales data processing apparatus 2, and performs payment processing. Then, after the payment in cash ends, an instruction of payment with an electronic payment card is received from the sales data processing apparatus 2, and payment processing with the electronic payment card is performed. Thus, the payment terminal 1 can perform payment processing according to separate payment methods.

The payment terminal I also includes an LED display section 20 for notifying the customer of the status of payment processing. Thus, the customer can know the status of the payment processing.

### Second Embodiment

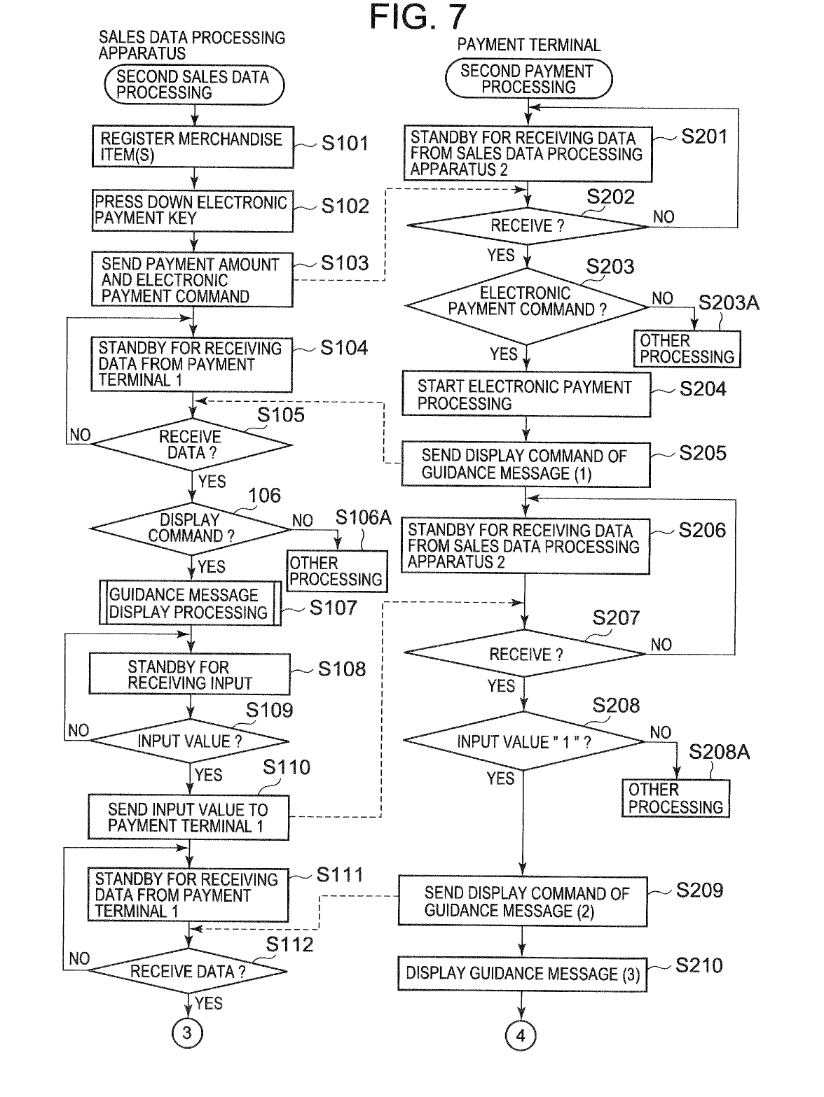

Next, the second embodiment of the present invention will be described with reference to FIG. 7 to FIG. 9. Below, the same reference numerals will be applied to the sections similar to those of the payment system 100 and the detailed descriptions incorporated herein, and the sections which are different will be described.

In coordination with a second sales data processing program, when a display command of a guidance message or a print command of sales slip print data is received from the payment terminal 1 through the connection section 39, the CPU 31 allows the display section 33 to display the guidance message according to the display form of the display section 33 or allows the print section 37 to print the sales slip print data according to the print form of the print section 37.

The form of output of the display section 33 means, for example, a specification of a number of lines of data displayed on the display section 33. The form of print of the print section 37 means, for example, a specification of the size of the width of the sheet to be printed.

The storage section 35 stores guidance messages (guidance message (1), guidance message (2) and guidance message (5)) Next, the operation of the payment system 100 will be described.

FIG. 7 is a flow chart showing a flow of a second sales data processing performed by the sales data processing apparatus 2 and a flow chart showing a flow of a second payment processing performed by the payment terminal 1.

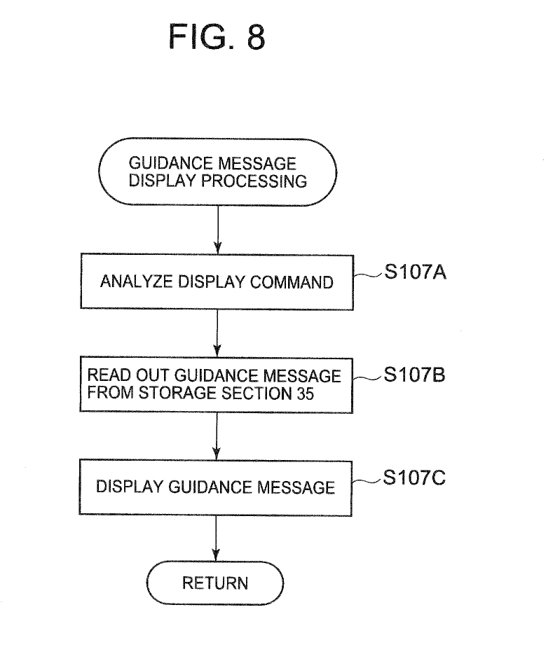

FIG. 8 is a flow chart showing a flow of a guidance message display processing.

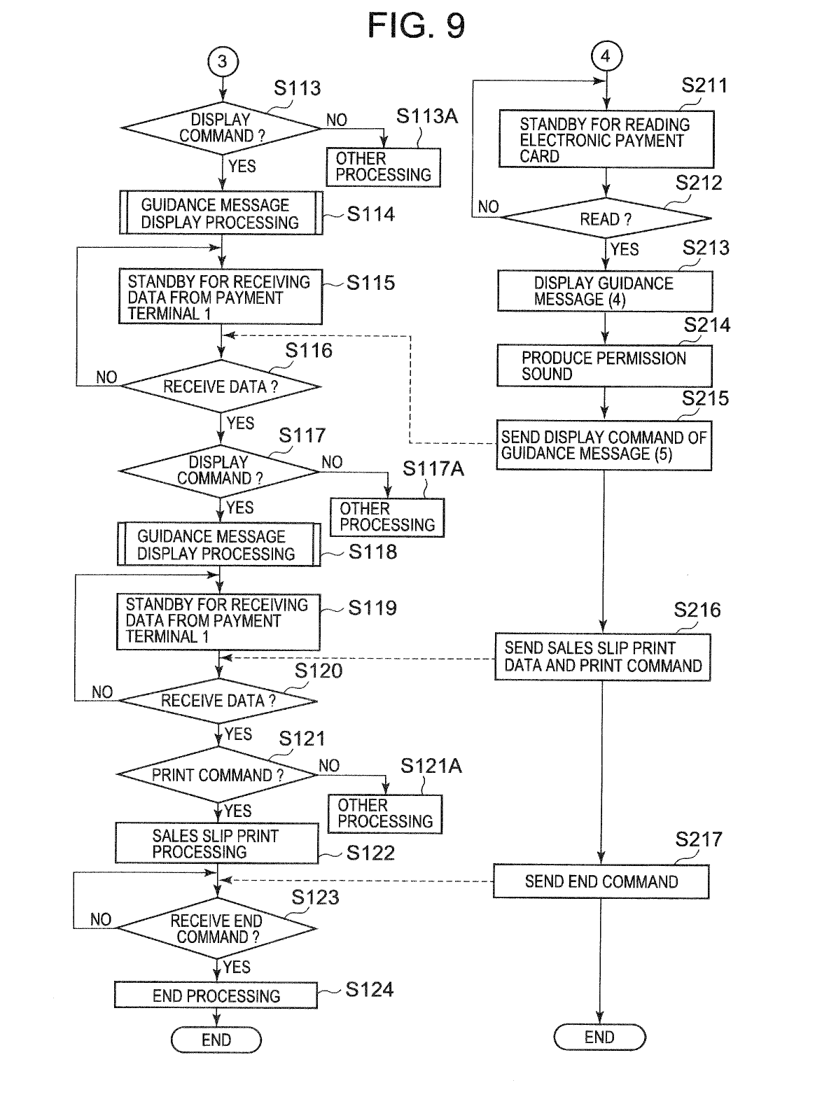

FIG. 9 is a flow chart showing a continuation of the flow of the second sales data processing performed by the sales data processing apparatus 2 and a flow chart showing a continuation of the flow of the second payment processing performed by the payment terminal 1.

The second sales data processing performed by the sales data processing apparatus 2 will be described. For example, when there is an instruction to perform the second sales data processing through the input section 32, in coordination with the CPU 31 and the second sales data processing program read out from the storage section 35 and developed to the RAM 34, the sales data processing apparatus 2 performs the second sales data processing.

Step S101 to step S104 are similar to step S11 to step S14 of the first sales data processing.

Corresponding to step S205, it is determined whether or not data is received from the payment terminal 1 through the connection section 39 (step S105). In other words, it is determined whether or not a display command of the guidance message (1) is received.

Step S106 and step S106A are similar to step S16 and step S16A of the first sales data processing. When step S106 is YES, the guidance message display processing is performed (step S107).

FIG. 8 is the flow chart showing the guidance message display processing. First, an analysis of the display command of the guidance message is performed (step S107A). Then, among the guidance messages stored in the storage section 35, the data designated by the display command is read out from the storage section 35 (step S107B). The read out guidance message is displayed on the display section 33 (step S107C) Then, the processing advances to step S108.

As an example, the display command of the guidance message (1) is to be a command for displaying three lines of display data of the guidance message (1) (“select task”, “1. sales, 2. reissue” and “3000 yen”). In this case, in step S107A, it is analyzed that the display command of the guidance message is a command including three lines of data. Then, in step S107B, the data of “select task”, “1. sales, 2. reissue” and “3000 yen” are selected from the guidance message (1) stored in the storage section 35 and read out. Then, in step S107C, the read out data of “select task”, “1. sales, 2. reissue” and “3000 yen” are displayed according to the display form of the display section 33. For example, when the display section 33 cannot display a large number of lines of data (for example, when only two lines can be displayed), the data of “select task”, “1. sales, 2. reissue” and “3000 yen” are displayed in two lines. Here, the data is displayed so that side scrolling is possible, and thus the user may view all of the data. When the display section 33 can display a large number of lines, all data of “select task”, “1. sales, 2. reissue” and “3000 yen” are displayed on the display section 33.

A processing similar to the above-described guidance message display processing is performed when displaying the guidance message (2) and the guidance message (5).

Step S108 is similar to step S18. After step S108, it is determined whether or not an input value is received (step S109) Here, as for input of the input value, when the display section 33 cannot display a large number of lines, the user inputs a number “1” or “2” through the input section 32. When the display section 33 can display a large number of lines and the input section 32 and the display section 33 are configured as a touch panel, displayed areas of “1. sales” or “2. reissue” displayed on the touch panel may be pressed.

Step S110 to step S111 are similar to step S20 to step S21 of the first sales data processing. After step S111, corresponding to step S209, it is determined whether or not data is received from the payment terminal 1 (step S112). In other words, it is determined whether or not the display command of the guidance message (2) is received.

Step S113 and step S113A are similar to step S23 and step 23A of the first sales data processing.

When step S113 is YES, the guidance message display processing is performed (step S114) In other words, regarding the guidance message (2), step S107A to step S107C is performed.

Step S115 is similar to step S25 of the first sales data processing. After step S115, corresponding to step S215, it is determined whether or not data is received from the payment terminal 1 (step S116) In other words, it is determined whether or not the display command of the guidance message (5) is received.

Step S117 and step S117A are similar to step S27 and step S27A of the first sales data processing.

When step S117 is YES, the guidance message display processing is performed (step S118) In other words, regarding the guidance message (5), step S107A to step S107C is performed.

Step S119 to step S121 and step S121A are similar to step S29 to step S31 and step S31A of the first sales data processing. When step S121 is YES, the sales slip print instruction processing is performed (step S122). Specifically, the sales slip print data is printed according to the output form of the print section 37. For example, even when the specification of the width of the sheet to be printed is different between the payment terminal 1 and the print section 37, the sales slip print data is printed according to the width of the sheet of the print section 37.

Step S123 and step S124 are similar to step S33 and step S34 of the first sales data processing. After step S124, the second sales data processing ends.

Next, the second payment processing performed by the payment terminal 1 will be described. For example, when there is an instruction to perform the second payment processing through the input section 12, in coordination with the CPU 11 and the second payment processing program read out from the storage section 16 and developed to the RAM 15, the payment terminal 1 performs the second payment processing.

Step S201 to step S204 and step S204A are similar to step S41 to step S44 and step S44A of the first payment processing. After step S204, the display command of the guidance message (1) is sent to the sales data processing apparatus 2 through the connection section 14 (step S205).

Step S206 to step S208 and step S208A are similar to step S46 to step S48 and step S48A of the first payment processing. When step S208 is YES, the display command of the guidance message (2) is sent to the sales data processing apparatus 2 through the connection section 14 (step S209).

Step S210 to step S217 are similar to step S50 to step S57 of the first payment processing. After step S210, the second payment processing ends.

According to the present embodiment, the guidance message is output on the display section 33 or the sales slip print data is output from the print section 37 based on the display specification of the display section 33 or the print specification of the print section 37 of the sales data processing apparatus 2. With this, the guidance message and the sales slip print data can be output according to the device specifications (display specification and print specification) of the sales data processing apparatus 2. The payment terminal 1 can perform the payment processing regardless of the specification (display specification and print specification) of the sales data processing apparatus 2.

Also, the input of selection of the guidance message displayed on the display section 33 is received. For example, as for the input of input value “1”, when the display section 33 cannot display a large number of lines, the user inputs the value “1” through the input section 32. When the display section 33 can display a large number of lines and the input section 32 and the display section 33 are configured as a touch panel, the user presses the displayed area of “1. sales” from “1. sales” or “2. reissue” displayed on the touch panel. In other words, the user may perform input of selection according to the form displayed on the display section 33.

The descriptions of the above-described embodiments are an example of the payment terminal, payment system and computer-readable medium of the embodiment of the present invention, and thus the present invention is not limited to the embodiments shown.

For example, in the above-described embodiment, the customer pays using an electronic payment card, however, payment is not limited to this method. Payment may be performed with, for example, a magnetic card, IC card, or portable terminal.

The detailed structure and operation of the payment system 100 of the above-described embodiment may be modified without leaving the scope of the spirit of the invention.

The entire disclosure of Japanese Patent Application No. 2007-222629 on Aug. 29, 2007 including specification, claims, drawings and abstract are incorporated herein by reference in its entirety.

Although various exemplary embodiments have been shown and described, the invention is not limited to the embodiments shown. Therefore, the scope of the invention is intended to be limited solely by the scope of the claims that follow.

What is claimed is:

1. A payment terminal comprising:
a connection section to connect to a data processing apparatus including an output section to output data;
a payment control section to send a first instruction to the data processing apparatus through the connection section to allow the output section to output payment data to be used in payment processing when a payment instruction is received from the data processing apparatus through the connection section, and to perform payment processing; and
an output control section to send a second instruction to the data processing apparatus through the connection section to allow the output section to output a result of the payment processing by the payment control section.

2. The payment terminal according to claim 1, further comprising an indicator to notify a customer of a status of the payment processing.

3. A payment system comprising:
the payment terminal according to claim 1; and
the data processing apparatus according to claim 1, wherein the data processing apparatus comprises:
a connection section of the data processing apparatus to connect to the payment terminal;
an output section to output data; and
a control section to allow the output section to output the payment data or the result of payment processing according to an output form of the output section when the first instruction to output the payment data used in the payment processing or the second instruction to output the result of the payment processing is received from the payment terminal through the connection section of the data processing apparatus.

4. The payment system according to claim 3, wherein the data processing apparatus comprises an input section to receive input of selection of payment data output to the output section by the control section.

5. A computer-readable medium embodying a program to allow a computer to function as:
a connection section to connect to a data processing apparatus including an output section to output data;
a payment control section to send a first instruction to the data processing apparatus through the connection section to allow the output section to output payment data to be used in payment processing when a payment instruction is received from the data processing apparatus through the connection section, and to perform payment processing; and
an output control section to send a second instruction to the data processing apparatus through the connection section to allow the output section to output a result of the payment processing by the payment control section.
